(19) United States
(12) Patent Application Publication
(10) Pub. No.: US 2019/0373889 A1
(43) Pub. Date: Dec. 12, 2019

(54) HIGH LOAD GRANULAR DINOTEFURAN FORMULATION WITH REDUCED EYE IRRITANCY

(71) Applicant: BASF SE, Ludwigshafen am Rhein (DE)

(72) Inventors: Claude Taranta, Limburgerhof (DE); Thomas Bork, Limburgerhof (DE); Simon Nord, Limburgerhof (DE); Michael Kranz, Limburgerhof (DE)

(21) Appl. No.: 16/470,619

(22) PCT Filed: Dec. 11, 2017
(86) PCT No.: PCT/EP2017/082123

§ 371 Date: Jun. 18, 2019

(30) Foreign Application Priority Data
Dec. 19, 2016 (EP) 16205043.9
Feb. 24, 2017 (EP) 17157866.9

(51) Int. Cl. A01N 43/08; A01N 43/56; A01N 25/12; A01N 25/30

(52) U.S. Cl. CPC A01N 43/08; A01N 25/30; A01N 25/12; A01N 43/56

(57) ABSTRACT

Described herein is a granular composition including a pesticide including dinotefuran, 1 to 15 wt % of a nonionic amphiphilic polyalkoxylate, and 1 to 10 wt % of an anionic dispersant. Also described herein is a method for a preparation of the composition including a step of contacting the pesticide, the dispersant, and the polyalkoxylate; and a method for controlling phytopathogenic fungi and/or undesired plant growth and/or undesired attack by insects or mites and/or for regulating a growth of plants, where the composition is allowed to act on particular pests, their habitat or plants to be protected from the particular pest, a soil and/or on undesired plants and/or useful plants and/or their habitat.

The present invention relates to a granular composition comprising a pesticide which comprises dinotefuran, 1 to 15 wt % of a nonionic amphiphilic polyalkoxylate, and 1 to 10 wt % of an anionic dispersant. It further relates to a granular composition comprising at least 40 wt % of a pesticide which preferably comprises dinotefuran, 1 to 15 wt % of a nonionic amphiphilic polyalkoxylate, and 1 to 10 wt % of an anionic dispersant. It further relates to a method for the preparation of the composition comprising the step of contacting the pesticide, the dispersant, and the polyalkoxylate; and to a method for controlling phytopathogenic fungi and/or undesired plant growth and/or undesired attack by insects or mites and/or for regulating the growth of plants, where the composition is allowed to act on the particular pests, their habitat or the plants to be protected from the particular pest, the soil and/or on undesired plants and/or the useful plants and/or their habitat. The present invention comprises combinations of preferred features with other preferred features.

There is an increasing need in the crop protection industry for soft toxicological profile and environmental friendly solutions, especially for the active ingredient dinotefuran. In several countries crop protection registration offices can make comparative assessment of new products versus existing commercial competitor products and eventually reject the submission of new entrant that would be more toxic than the local market standards. Additionally, for certain crops with secondary certifiers the use of crop protection products with bad toxicity class is hardly acceptable.

In parallel to the low toxicity requirements a high loading of pesticide in the crop protection product is advantageous. This reduces costs for transportation and storage space for the producer, distributor and farmer. Object of the present invention was to overcome said problems of the state of the art, especially for agroformulations comprising dinotefuran.

These objects were solved in one form with a granular composition comprising
a pesticide which comprises dinotefuran,
1 to 15 wt % of a nonionic amphiphilic polyalkoxylate, and
1 to 10 wt % of an anionic dispersant.

In another form, these objects were solved with a granular composition comprising
at least 40 wt % of a pesticide which preferably comprises dinotefuran,
1 to 15 wt % of a nonionic amphiphilic polyalkoxylate, and
1 to 10 wt % of an anionic dispersant.

The granules may have a particle size distribution of D50 from 0.05 to 10 mm, preferably from 0.1 to 5 mm. The granules may have a particle size distribution of D90 from 0.1 to 15 mm, preferably from 0.3 to 7 mm. The composition may be a solid composition at ambient temperature. The composition comprises at least 80 wt %, preferably at least 90, and in particular at least 95 wt % granules.

The term pesticides usually refers to at least one active substance selected from the group of the fungicides, insecticides, nematicides, herbicides, safeners, biopesticides and/or growth regulators. Preferred pesticides are fungicides, insecticides, herbicides and growth regulators. Especially preferred pesticides are insecticides. Mixtures of pesticides of two or more of the abovementioned classes may also be used, such as a mixture of an insecticide (e.g. dinotefuran) with a fungicide. The skilled worker is familiar with such pesticides, which can be found, for example, in the Pesticide Manual, 17th Ed. (2015), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxy-propionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

The composition may comprise one or more pesticides.

The pesticide may have a melting point of at least 30° C., preferably at least 45° C. and in particular of at least 60° C. In case the composition contains a mixture of pesticides usually all pesticides may have a melting point of at least 30° C., preferably at least 45° C. and in particular of at least 60° C.

The composition contains usually more than 40 wt % of the pesticide, preferably more than 45 wt %, and in particular more than 50 wt %. In another form, the composition comprises more than 40 wt % and up to 90 wt % of the pesticide, preferably more than 48 wt % and up to 80 wt % of the pesticide, and in particular more than 53 wt % and up to 75 wt % of the pesticide. In case the composition contains a mixture of pesticides these amounts refer to the sum of all pesticides.

The pesticide may be water soluble or water insoluble. Mixtures of a water-soluble pesticide and a water insoluble pesticide are also possible. In a preferred form, the composition comprises at least one pesticide which has a solubility in water of at least 5 g/l, preferably of at least 15 g/l, and in particular of at least 30 g/l at 20° C., usually at neutral pH.

The pesticide may comprise dinotefuran and optionally a further pesticide. Preferably, the pesticide comprises dinotefuran and a fungicide, such as fluxapyroxad.

The composition may comprise at least 5 wt %, preferably at least 10 wt %, and in particular at least 15 wt % dinotefuran.

The composition may comprise at least 5 wt % (preferably at least 10 wt %, and in particular at least 15 wt %) dinotefuran, and at least 10 wt % (preferably at least 20 wt %, and in particular at least 30 wt %) of a fungicide such as fluxapyroxad.

In a preferred form, the composition comprises more than 40 wt % of the pesticide which comprises dinotefuran, and the composition comprises at least 5 wt % (preferably at least 10 wt %, and in particular at least 15 wt %) dinotefuran.

In another preferred form, the composition comprises more than 40 wt % of the pesticide which comprises dinotefuran, and the composition comprises at least 5 wt % (preferably at least 10 wt %, and in particular at least 15 wt %) dinotefuran, and a fungicide (preferably fluxapyroxad).

In another preferred form, the composition comprises more than 40 wt % of the pesticide which comprises dinotefuran, and the composition comprises at least 5 wt % (preferably at least 10 wt %, and in particular at least 15 wt %) dinotefuran, and at least 10 wt % (preferably at least 20 wt %, and in particular at least 30 wt %) of a fungicide such as fluxapyroxad.

Suitable nonionic amphiphilic polyalkoxylate are usually free of ionic groups. The polyalkoxylate is amphiphilic, which usually means that is has surfactant properties and lowers the surface tension of water. Usually, the polyalkoxylate is obtainable by alkoxylation using alkyleneoxides, such as C₂-C₆-alkylene oxide, preferably ethylene oxide, propylene oxide, or butylene oxide. Examples of polyalkoxylates are block polymers or compounds such as alcohols, alkylphenols, amines, amides, arylphenols, fatty acids or fatty acid esters which have been alkoxylated with 1 to 50 equivalents.

The polyalkoxylate may have a melting point of at least 35° C., preferably at least 43° C., more preferably at least 48° C. and in particular at least 50° C.

The polyalkoxylate is usually soluble in water at 20° C., and e.g. at pH 7. Preferably, the solubility in water of the polyalkoxylate is at least 3 wt %, more preferably at least 7 wt %, and in particular at least 10 wt %.

The molecular weight of the polyalkoxylate is usually in the range of from 0.5 to 50 kDa, preferably from 2 to 35 kDa, and in particular from 5 to 20 kDa.

The polyalkoxylate is preferably a block polymer, which may contain a hydrophilic block and a hydrophobic block. Suitable block polymers are block polymers of the A-B or A-B-A type comprising blocks of polyethylene oxide and polypropylene oxide, or of the A-B-C type comprising alkanol, polyethylene oxide and polypropylene oxide.

Preferably, the polyalkoxylate is a block polymer comprising at least one polyethoxylate block and at least one poly-C₃-C₅-alkoxylate block (e.g. polypropoxylate or polybutoxylate).

In particular, the polyalkoxylate is a triblock polymer of A-B-A type comprising a polyethoxylate type A block and a poly-C₃-C₅-alkoxylate block (preferably polypropoxylate) type B block.

The composition may comprise 1 to 12 wt %, preferably 1 to 10 wt %, and in particular 2 to 8 wt % of the polyalkoxylate.

In a preferred form, the composition comprises a sugar, which is a mono-or disaccharide or a mixture thereof. The sugar is preferably soluble in water, e.g. at least 5 g/l, preferably at least 50 g/l, and in particular at least 100 g/l each at 20° C., e.g. at pH 7.

Suitable sugars are mono- or disaccharides (e.g. lactose, fructose, saccharose, maltose, glucose), especially disaccharides, such as lactose. Mixtures of sugars are also possible. More preferred sugars are lactose, fructose, saccharose, maltose, glucose, or mixtures thereof.

The composition comprises at least 5 wt %, preferably at least 10 wt %, and in particular at least 15 wt % of the sugar. In another form, the composition may comprise 5 to 50 wt %, preferably 10 to 40 wt %, and in particular 15 to 35 wt % of the sugar. In another form, the amount of sugar is used to fill up all other components of the composition to a sum of 100 wt %.

The composition comprises an anionic dispersant. The composition comprises preferably a solid water-soluble anionic dispersant. The dispersant is usually solid at 25° C., or it may have a melting point of at least 30° C., preferably at least 50° C., and in particular at least 100° C. The dispersant is soluble in water, e.g. at least 50 g/l, preferably at least 100 g/l, each at 20° C., and e.g. at pH 7.

Suitable dispersants are alkali, alkaline earth or ammonium salts of sulfonates, sulfates, phosphates, polycarboxylate, and mixtures thereof.

Examples of sulfates are sulfates of fatty acids and oils, of ethoxylated alkylphenols, of alcohols, of ethoxylated alcohols, or of fatty acid esters. Examples of phosphates are phosphate esters.

Examples of sulfonates are sulfonated phenol-formaldehyde condensation products, sulfonated cresol-formaldehyde condensation products, alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes or alkylnaphthalenes, sulfonates of dodecyl- and tridecylbenzenes, sulfonates of naphthalenes and alkylnaphthalenes, sulfosuccinates or sulfosuccinamates. Typically, the sulfonates have a molecular weight from 200 to 2000 g/mol, preferably from 250 to 1000 g/mol.

Preferred sulfonates are alkali, alkaline earth or ammonium salts of sulfonates, more preferably sulfonated aryl-formaldehyde condensation products, such as alkali salts of sulfonated phenol-formaldehyde condensation products (e.g. CAS 102980-04-1), sulfonated naphthalene-formaldehyde condensation products (e.g. CAS 9084-06-4, 68425-94-5, 83453-42-3, or 9008-63-3), sulfonated alkylnaphthalene condensation products, and/or sulfonated cresol-formaldehyde condensation products (e.g. CAS 115535-44-9).

Examples of polycarboxylates are polymers, which may comprise several carboxylic acid groups in free acid form and/or as salt. In particular, polycarboxylates are copolymers of ethylenically unsaturated carboxylic acid and/or anhydride. Preferred polycarboxylates are copolymers of at least one ethylenically unsaturated carboxylic acid and/or anhydride, and of at least one ethylenically unsaturated nonionic monomer. More preferred polycarboxylates are copolymers of an ethylenically unsaturated, linear or branched aliphatic, cycloaliphatic or aromatic monocarboxylic or polycarboxylic acid or anhydride and of alpha-monoolefins containing from 2 to 20 carbon atoms. Suitable acid or anhydride monomers are selected from acrylic, methacrylic, crotonic, maleic, fumaric, citraconic or itaconic acid or anhydride, wherein maleic acid and/or its anhydride are most preferred. Suitable ethylenically unsaturated nonionic monomers are alpha-monoolefin monomers, such as ethylene, propylene, 1-butene, isobutylene, n-1-pentene, 2-methyl-1-butene, n-1-hexene, 2-methyl-1-pentene, 4-methyl-1-pentene, 2-ethyl-1-butene, diisobutylene (or 2,4,4-trimethyl-1-pentene) and 2-methyl-3,3-dimethyl-1-pentene. Mixtures of such monomers are also suitable. The molar ratio between ethylenically unsaturated nonionic monomers and acid or anhydride monomers may be in the range from 20/80 to 80/20, preferably from 30/70 to 70/30, and in particular from 40/60 to 60/40.

The molecular weight of the polycarboxylate may be 1 to 40 kDa, preferably 2 to 20 kDa, and in particular 3 to 14 kDa.

In a preferred form, the dispersant comprises a sulfate, a sulfonate, a polycarboxylate, or mixtures thereof.

In another preferred form, the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products, and/or sulfonates of alkylnaphthalenes).

In a more preferred form the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products and/or sulfonates of alkylnaphthalenes), and where the composition comprises less than 5 wt % of the sulfonate.

In another preferred form, the dispersant consists of at least one sulfonate (e.g. sulfonated aryl-formaldehyde condensation products and/or sulfonates of alkylnaphthalenes), and at least one polycarboxylate (such as a copolymer of at least one ethylenically unsaturated carboxylic acid and/or anhydride, and of at least one ethylenically unsaturated nonionic monomer). In case the dispersant consists of at least one sulfonate and at least one polycarboxylate it usually means that the composition is free of any other anionic dispersants beside the at least one sulfonate and the at least one polycarboxylate.

In a preferred form, the composition is free of an anionic dispersant selected from sulfates, such as sulfates of fatty acids, in particular lauryl sulfate.

The composition comprises 1 to 10 wt %, preferably 1 to 9 wt %, and in particular 1 to 8 wt % of the dispersant. In another form, the composition may comprise from 3 to 10 wt %, preferably 3 to 9 wt %, and in particular 4 to 8 wt % of the dispersant.

The composition may comprise 1 to 8 wt %, preferably 1 to 6 wt %, and in particular 1 to 5 wt % of the sulfonate (e.g. sulfonated aryl-formaldehyde condensation products and/or sulfonates of alkylnaphthalenes).

The composition may comprise less than 5 wt %, preferably less than 3 wt %, and in particular less than 2 wt % of a sulfonate of an alkylnaphthalene.

The composition may comprise 1 to 9 wt %, preferably 1 to 8 wt %, and in particular 1 to 7 wt % of the polycarboxylate (such as a copolymer of at least one ethylenically unsaturated carboxylic acid and/or anhydride, and of at least one ethylenically unsaturated nonionic monomer).

The composition comprises 1 to 10 wt %, preferably 1 to 9 wt %, and in particular 1 to 8 wt % of the dispersant, where the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products and/or a sulfonate of an alkylnaphthalene).

The composition comprises 1 to 10 wt %, preferably 1 to 9 wt %, and in particular 1 to 8 wt % of the dispersant, where the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products and/or a sulfonate of an alkylnaphthalene), and where the composition comprises less than 7 wt % (preferably less than 5 wt %) of the sulfonate.

The composition comprises 1 to 10 wt %, preferably 1 to 9 wt %, and in particular 1 to 8 wt % of the dispersant, where the dispersant consists of at least one sulfonate (e.g. sulfonated aryl-formaldehyde condensation products and/or a sulfonate of an alkylnaphthalene), and at least one polycarboxylate (such as a copolymer of at least one ethylenically unsaturated carboxylic acid and/or anhydride, and of at least one ethylenically unsaturated nonionic monomer).

The weight ratio of the dispersant to the polyalkoxylate is usually in the range from 5:1 to 1:3, preferably from 3:1 to 1:2, and in particular from 1.5:1 to 1:1.5.

In a preferred form, the composition is free of a polyvinylpyrrolidone. The term polyvinyl-pyrrolidone usually refers to homopolymers of vinylpyrrolidone, copolymers of vinylpyrrolidone, which comprise at least 80 mol % of vinylpyrrolidone (based on the total amount of monomers in the copolymer), or mixtures thereof.

In a preferred form, the composition is free of a water-insoluble solvent. The term water-insoluble solvent usually refers to solvents which have a solubility in water of up to 20 g/l at 25° C. The term water-insoluble solvent usually refers to solvents which have a boiling point of at least 110° C. The term water-insoluble solvent usually refers to solvents which have a flash point of at least 60° C. Examples of water-insoluble solvents are
N-C₄-C₁₂-alkylpyrrolidone, preferably N-C₆-C10-alkylpyrrolidone, e.g. N-octylpyrrolidone;
N,N-dimethyl C₆-C₁₄ alkanamides, preferably N,N-dimethyl C₈-C₁₂ alkanamides;
C₅-C₁₂-alkyl lactates, preferably C6-C₁₀-alkyl lactates, e.g. 2-ethylhexyl lactate;
aliphatic and/or aromatic hydrocarbons having a boiling point of at least 140° C., preferably aromatic hydrocarbons having a boiling point of at least 180° C.;
C₁-C₁₂ alkylphenols, preferably C₂-C₁₀ alkylphenols, e.g. 2-(1-methylpropyl)phenol;
C₄-C₂₂ alkyl or C₆-C₂₂ aryl benzoate, preferably C₆-C₁₂ aryl benzoate, e.g. benzyl benzoate; and
di-C₄-C₂₂ alkyl phthalates, preferably di-C₆-C₁₄ alkyl phthalates, e.g. diisononyl phthalate.

Usually, the composition is essentially free of water, e.g. it comprises less than 10 wt %, preferably less than 5 wt %, and in particular less than 3 wt % water.

The composition may further comprise a fatty acid salt. Suitable fatty acid salts are alkali, alkaline earth or ammonium salts of fatty acids, wherein alkali salts are preferred. The term fatty acid usually refers to C10 to C22 alkyl carboxylic acid, preferably to C14 to C20 alkyl carboxylic acid. Fatty acids are typically mixtures of the alkyl carboxylic acid. The composition may comprise from 0.1 to 8 wt %, preferably from 0.3 to 5 wt %, and in particular from 0.5 to 3 wt % of the fatty acid salt.

The composition may comprise auxiliaries, such as bactericides, anti-foaming agents or colorants.

Suitable bactericides are bronopol and isothiazolinone derivatives such as alkylisothiazolinones and benzisothiazolinones.

Suitable anti-foaming agents are silicones or long chain alcohols.

Suitable colorants (e.g. in red, blue, or green) are pigments of low water solubility and water-soluble dyes. Examples are inorganic colorants (e.g. iron oxide, titan oxide, iron hexacyanofer-rate) and organic colorants (e.g. alizarin-, azo- and phthalocyanine colorants).

In a preferred form, the composition comprises
more than 40 wt % preferably more than 45 wt %, and in particular more than 50 wt % of the pesticide,
1 to 15 wt %, preferably 1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt %, preferably 1 to 9 wt %, and in particular 1 to 8 wt % of the dispersant, where the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products and/or a sulfonate of an alkylnaphthalene).

In another preferred form, the composition comprises
the pesticide which comprises dinotefuran and optionally a fungicide,
1 to 15 wt %, preferably 1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt %, preferably 1 to 9 wt %, and in particular 1 to 8 wt % of the dispersant, where the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products and/or a sulfonate of an alkylnaphthalene).

In a preferred form, the composition comprises
more than 40 wt % preferably more than 45 wt %, and in particular more than 50 wt % of the pesticide,
1 to 15 wt %, preferably 1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt %, preferably 1 to 9 wt %, and in particular 1 to 8 wt % of the dispersant, where the dispersant where the dispersant consists of at least one sulfonate (e.g. sulfonated aryl-formaldehyde condensation products and/or a sulfonate of an alkylnaphthalene), and at least one polycarboxylate (such as a copolymer of at least one ethylenically unsaturated carboxylic acid and/or anhydride, and of at least one ethylenically unsaturated nonionic monomer).

In another preferred form, the composition comprises
the pesticide which comprises dinotefuran and optionally a fungicide,
1 to 15 wt %, preferably 1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt %, preferably 1 to 9 wt %, and in particular 1 to 8 wt % of the dispersant, where the dispersant where the dispersant consists of at least one sulfonate (e.g. sulfonated aryl-formaldehyde condensation products and/or a sulfonate of an alkylnaphthalene), and at least one polycarboxylate (such as a copolymer of at least one ethylenically unsaturated carboxylic acid and/or anhydride, and of at least one ethylenically unsaturated nonionic monomer).

In another preferred form, the composition comprises
more than 50 wt % of the pesticide,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products).

In another preferred form, the composition comprises
more than 40 wt % of the pesticide which comprises dinotefuran, and the composition comprises at least 5 wt % (preferably at least 10 wt %, and in particular at least 15 wt %) dinotefuran,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant comprises a polycarboxylate (such as a copolymer of at least one ethylenically unsaturated carboxylic acid and/or anhydride, and of at least one ethylenically unsaturated nonionic monomer) and sulfonate (e.g. sulfonated aryl-formaldehyde condensation products).

In another preferred form, the composition comprises
more than 50 wt % of the pesticide,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant where the dispersant consists of at least one sulfonate (e.g. sulfonated aryl-formaldehyde condensation products and/or a sulfonate of an alkylnaphthalene), and at least one polycarboxylate (such as a copolymer of at least one ethylenically unsaturated carboxylic acid and/or anhydride, and of at least one ethylenically unsaturated nonionic monomer).

In another preferred form, the composition comprises
more than 40 wt % of the pesticide which comprises dinotefuran, and the composition comprises at least 5 wt % (preferably at least 10 wt %, and in particular at least 15 wt %) dinotefuran,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant where the dispersant consists of at least one sulfonate (e.g. sulfonated aryl-formaldehyde condensation products and/or a sulfonate of an alkylnaphthalene), and at least one polycarboxylate (such as a copolymer of at least one ethylenically unsaturated carboxylic acid and/or anhydride, and of at least one ethylenically unsaturated nonionic monomer).

In another preferred form, the composition comprises
more than 40 wt % of the pesticide,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant comprises a polycarboxylate which is a copolymer of at least one ethylenically unsaturated carboxylic acid and/or anhydride, and of at least one ethylenically unsaturated nonionic monomer, and sulfonate which comprises sulfonated aryl-formaldehyde condensation products.

In another preferred form, the composition comprises
at least 5 wt % (preferably at least 10 wt %, and in particular at least 15 wt %) dinotefuran, and at least 10 wt % (preferably at least 20 wt %, and in particular at least 30 wt %) of a fungicide such as fluxapyroxad,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant comprises a polycarboxylate which is a copolymer of at least one ethylenically unsaturated carboxylic acid and/or anhydride, and of at least one ethylenically unsaturated nonionic monomer, and sulfonate which comprises sulfonated aryl-formaldehyde condensation products.

In another preferred form, the composition comprises
more than 40 wt % of the pesticide,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant where the dispersant consists of at least one sulfonate selected from sulfonated aryl-formaldehyde condensation products and/or a sulfonate of an alkylnaphthalene, and at least one copolymer of at least one ethylenically unsaturated carboxylic acid and/or anhydride, and of at least one ethylenically unsaturated nonionic monomer.

In another preferred form, the composition comprises
at least 5 wt % (preferably at least 10 wt %, and in particular at least 15 wt %) dinotefuran, and at least 10 wt % (preferably at least 20 wt %, and in particular at least 30 wt %) of a fungicide such as fluxapyroxad,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 10 wt % of the dispersant, where the dispersant where the dispersant consists of at least one sulfonate selected from sulfonated aryl-formaldehyde condensation products and/or a sulfonate of an alkylnaphthalene, and at least one copolymer of at least one ethylenically unsaturated carboxylic acid and/or anhydride, and of at least one ethylenically unsaturated nonionic monomer.

In another preferred form, the composition comprises
more than 50 wt % of the pesticide,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 8 wt % of the dispersant, where the dispersant comprises a polycarboxylate which is a copolymer of at least one ethylenically unsaturated carboxylic acid and/or anhydride, and of at least one ethylenically unsaturated nonionic monomer, and sulfonate which comprises sulfonated aryl-formaldehyde condensation products.

In another preferred form, the composition comprises
more than 40 wt % of the pesticide which comprises dinotefuran, and the composition comprises at least 5 wt % (preferably at least 10 wt %, and in particular at least 15 wt %) dinotefuran, and at least 10 wt % (preferably at least 20 wt %, and in particular at least 30 wt %) of a fungicide such as fluxapyroxad,
1 to 10 wt %, and in particular 2 to 8 wt % of the nonionic amphiphilic polyalkoxylate, where the polyalkoxylate is a block polymer comprising a polyethoxylate block and a poly-C₃-C₅-alkoxylate block, and
1 to 8 wt % of the dispersant, where the dispersant comprises a polycarboxylate which is a copolymer of at least one ethylenically unsaturated carboxylic acid and/or anhydride, and of at least one ethylenically unsaturated nonionic monomer, and sulfonate which comprises sulfonated aryl-formaldehyde condensation products.

The invention further relates to a method for the preparation of the composition as defined above comprising the step of contacting the pesticide, the dispersant, and the polyalkoxylate.

The method for the preparation usually comprises a granulation step. The granulation may be done by any known granulation technology, such as pan or drum granulation, mixing agglomeration, extrusion granulation, fluid bed granulation, tableting, or spray drying granulation.

Typically, the method for the preparation of the composition comprises the contacting of the pesticide, the dispersant, and the polyalkoxylate, the wetting of the components with water, extrusion granulation, and optionally drying and sieving of the granules.

The invention further relates to a method for controlling phytopathogenic fungi and/or undesired plant growth and/or undesired attack by insects or mites and/or for regulating the growth of plants, where the composition is allowed to act on the particular pests, their habitat or the plants to be protected from the particular pest, the soil and/or on undesired plants and/or the useful plants and/or their habitat. The method for controlling phytopathogenic fungi and/or undesired plant growth and/or undesired attack by insects or mites and/or for regulating the growth of plants may exclude a therapeutic use.

When employed in plant protection, the amounts of pesticide applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

Various types of oils, wetters, adjuvants, fertilizer, or micronutrients, and other pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

The present offers various advantages: it has a reduced toxicity, such as a reduced eye toxicity, a high loading of pesticide in the crop protection product, which reduces costs for transportation and storage space for the producer, distributor and farmer.

The examples which follow illustrate the invention without imposing any limitation.

### EXAMPLES

Polyalkoxylate: EO-PO-EO triblock polymer, Molecular weight 10-15 kDa, containing 70-75 wt % EO; >10 wt % water-soluble, melting point about 55° C.
Lactose: lactose monohydrate
Additive A: sodium tallowate, powder
Additive B: aliphatic C₆ carboxylic acid, >5 wt % soluble in water
Defoamer: Silicon based defoamer
Dispersant 1: Copolymer of maleic acid/diisobutylene, sodium salt, 25 wt % solution in water, molecular weight 10-12 kDa
Dispersant 2: Alkyl naphthalene sulfonate, sodium salt, powder, water soluble, surface tension about 29-33 mN/m (DIN 53914)
Dispersant 3: Sodium salt of naphthalene sulfonate formaldehyde condensate, powder, water soluble

### Example 1—Preparation

Granules were prepared by mixing the components according to Table 1. The powdery mixture was then dry milled with a jet mill. A small amount of water was added to provide a wetted powder that is extruded (die with about 1 mm cross sections), dried in a fluidized bed chamber and optionally sieved.

TABLE 1
Composition of granules (all data in wt %)

| | A | B |
|---|---|---|
| Fluxapyroxad | 40 | 40 |
| Dinotefuran | 20 | 20 |
| Polyalkoxylate | 6.0 | 6.0 |
| Dispersant 1 | 6.0 | 2.0 |
| Dispersant 2 | 1.0 | — |
| Dispersant 3 | — | 4.0 |
| Defoamer | 0.5 | 0.5 |
| Additive A | 1.0 | 1.0 |
| Additive B | 1.0 | 1.0 |
| Lactose | Filled up to 100 | Filled up to 100 |

### Example 2—Eye Toxicity

This study was performed in accordance with the German Animal Welfare Act and the European Council Directive 86/609/EEC on the approximation of laws, regulations and administrative provisions of the Member States regarding the protection of animals used for experimental and other scientific purposes.

The potential of the Composition A and B from Example 1 to cause damage to the conjunctiva, iris or cornea was assessed by a single ocular application of the undiluted test sample to one eye of three New Zealand White rabbits (stepwise procedure starting with one animal and supplementing two additional animals). About 1 hour (not less) after application the eye was rinsed with tap water. The ocular reactions were assessed at 1, 24, 48, 72 hours. The results are summarized in Tables 1 and 2.

There was no corneal opacity observed for neither Composition A and B. Any slight effects in the conjunctiva were reversible at 72 h (Composition A) or 48 h (Composition B).

TABLE 1
Eye toxicity testing results for Sample 1A (“1”
means a clinical observation of a slight conjunctival redness
(grade 1), or a slight conjunctival chemosis (grade 1)).

| | | Cornea | | | | | |
|---|---|---|---|---|---|---|---|
| | | | Area | | Conjunctiva | | |
| Read- | Animal | Opac- | of cornea | | Red- | Chemo- | Dis- |
| ings | No. | ity | involved | Iris | ness | sis | charge |
| 1 h | 1 | 0 | 0 | 0 | 1 | 1 | 0 |
| | 2 | 0 | 0 | 0 | 1 | 1 | 0 |
| | 3 | 0 | 0 | 0 | 1 | 1 | 0 |
| 24 h | 1 | 0 | 0 | 0 | 0 | 0 | 0 |
| | 2 | 0 | 0 | 0 | 1 | 0 | 0 |
| | 3 | 0 | 0 | 0 | 1 | 0 | 0 |
| 48 h | 1 | 0 | 0 | 0 | 0 | 0 | 0 |
| | 2 | 0 | 0 | 0 | 1 | 0 | 0 |
| | 3 | 0 | 0 | 0 | 1 | 0 | 0 |
| 72 h | 1 | 0 | 0 | 0 | 0 | 0 | 0 |
| | 2 | 0 | 0 | 0 | 0 | 0 | 0 |
| | 3 | 0 | 0 | 0 | 0 | 0 | 0 |
| Mean | — | 0, 0 | — | 0, 0 | 0, 4 | 0, 0 | — |

TABLE 2
Eye toxicity testing results for Sample 1B (“1”
means a clinical observation of a slight conjunctival redness
(grade 1), or a slight conjunctival chemosis (grade 1)).

| | | Cornea | | | | | |
|---|---|---|---|---|---|---|---|
| | | | Area | | Conjunctiva | | |
| Read- | Animal | Opac- | of cornea | | Red- | Chemo- | Dis- |
| ings | No. | ity | involved | Iris | ness | sis | charge |
| 1 h | 1 | 0 | 0 | 0 | 1 | 0 | 0 |
| | 2 | 0 | 0 | 0 | 1 | 0 | 0 |
| | 3 | 0 | 0 | 0 | 1 | 1 | 0 |
| 24 h | 1 | 0 | 0 | 0 | 0 | 0 | 0 |
| | 2 | 0 | 0 | 0 | 0 | 0 | 0 |
| | 3 | 0 | 0 | 0 | 1 | 0 | 0 |
| 48 h | 1 | 0 | 0 | 0 | 0 | 0 | 0 |
| | 2 | 0 | 0 | 0 | 0 | 0 | 0 |
| | 3 | 0 | 0 | 0 | 0 | 0 | 0 |
| 72 h | 1 | 0 | 0 | 0 | 0 | 0 | 0 |
| | 2 | 0 | 0 | 0 | 0 | 0 | 0 |
| | 3 | 0 | 0 | 0 | 0 | 0 | 0 |
| Mean | — | 0, 0 | — | 0, 0 | 0, 1 | 0, 0 | — |

This study was performed in accordance with the following rules:
OECD Guideline for Testing of Chemicals No. 405, Oct. 2, 2012 (“Acute Eye Irritation/Corrosion”)
Commission Regulation (EC) No 440/2008 of 30 May 2008 laying down test methods pursuant to Regulation (EC) No 1907/2006 of the European Parliament and of the Council on the Registration, Evaluation, Authorization and Restriction of Chemicals (REACH), Part B: Methods for the determination of toxicity and other health effects. Acute Toxicity: Eye Irritation/Corrosion; Official Journal of the European Union, No. L 142
U.S. EPA Health Effects Test Guidelines OPPTS 870.2400, August 1998 (“Acute Eye Irritation”)
Japan MAFF Testing Guideline of 12 Nousan No. 8147, Nov. 24, 2000 as this is in line with OECD Guideline No. 405.
OECD Principles of Good Laboratory Practice and the GLP Principles of the German “Chemikaliengesetz” in the current edition (Chemicals Act), which meet the United States Environmental Protection Agency Good Laboratory Practice Standards [40 CFR Part 160 (FIFRA) and Part 792 (TSCA)], with the exception that recognized differences exist between the GLP Principles/Standards of OECD and the Principles/Standards of FIFRA and TSCA.

1. A granular composition comprising
a pesticide comprising dinotefuran,
1 to 15 wt % of a nonionic amphiphilic polyalkoxylate, and
1 to 10 wt % of an anionic dispersant.

2. The composition according to claim 1 comprising more than 40 wt % of the pesticide.

3. The composition according to claim 1, wherein the polyalkoxylate is a block polymer comprising a polyethoxylate block and a poly-C₃-C₅-alkoxylate block.

4. The composition according to claim 1, further comprising a sugar, which is a mono- or disaccharide or a mixture thereof.

5. The composition according to claim 1, comprising at least 5 wt % dinotefuran.

6. The composition according to claim 1, further comprising a fatty acid salt.

7. The composition according to claim 1, comprising 1 to 8 wt % of the dispersant.

8. The composition according to claim 1, wherein a weight ratio of the dispersant to the polyalkoxylate is in a range from 5:1 to 1:3.

9. The composition according to claim 1, wherein the dispersant comprises a sulfate, a sulfonate, a polycarboxylate, or mixtures thereof.

10. The composition according to claim 1, wherein the dispersant consists of at least one sulfonate, and at least one polycarboxylate.

11. The composition according to claim 1, wherein the dispersant comprises a polycarboxylate and sulfonate, and wherein the composition comprises less than 5 wt % of the sulfonate.

12. The composition according to claim 1, wherein the composition is free of a polyvinylpyrrolidone.

13. The composition according to claim 1, wherein the composition is free of a water-insoluble solvent.

14. The composition according to claim 1, wherein the composition comprises less than 3 wt % of a sulfonate of an alkylnaphthalene.

15. The composition according to claim 1, wherein said pesticide comprises dinotefuran and a fungicide.

16. A method for a preparation of the composition as defined in claim 1, the method comprising a step of contacting the pesticide, the dispersant, and the polyalkoxylate.

17. A method for controlling phytopathogenic fungi and/or undesired plant growth and/or undesired attack by insects or mites and/or for regulating a growth of plants, wherein the composition as defined in claim 1 is allowed to act on particular pests, their habitat or plants to be protected from the particular pest, a soil and/or on undesired plants and/or useful plants and/or their habitat.

18. The composition according to claim 1 comprising more than 50 wt % of the pesticide.

19. The composition according to claim 1, comprising at least 10 wt % dinotefuran.

20. The composition according to claim 1, wherein said pesticide comprises dinotefuran and fluxapyroxad.
